(19) United States
(12) Patent Application Publication
(10) Pub. No.: US 2014/0352224 A1
(43) Pub. Date: Dec. 4, 2014

(54) REMOVABLE, CHANGEABLE AND REPLACEABLE DOUBLE OPENING WINDOW

(71) Applicant: Emilio Diaz GASCON, La Cartuja (Zaragoza) (ES)

(72) Inventor: Emilio Diaz GASCON, La Cartuja (Zaragoza) (ES)

(21) Appl. No.: 14/291,365

(22) Filed: May 30, 2014

(30) Foreign Application Priority Data
Jun. 4, 2013 (ES) 201330816

(51) Int. Cl. B60J 1/00; E06B 7/16; E05F 11/00; E06B 5/00

(52) U.S. Cl. CPC B60J 1/005; E06B 5/00; E06B 7/16; E05F 11/00; B60J 1/007
USPC 49/460; 49/465

(57) ABSTRACT

An easily removable, changeable and replaceable window for application on train carriages, passenger buses and other transport vehicles that consists of an assembly formed by a removable window frame and the corresponding rim thereof fixed on the chassis of the vehicle, said assembly being provided with a closing and opening device that may be actuated both from the inside and the outside, and therefore, enabling a glazed window to be released for safety reasons or to be released and changed for maintenance reasons, without losing time or functionality.

### OBJECT OF THE INVENTION

The following invention relates to an easily removable, changeable and

replaceable window assembly, for application essentially on train carriages, passenger buses and other transport vehicles, that consists of a removable window frame and the corresponding rim thereof fixed on the chassis of the vehicle, said assembly being provided with a closing and opening device that may be actuated both from the inside and the outside, and therefore, enabling a glazed window to be released for safety reasons or be released and changed for maintenance reasons, without losing time or functionality.

### BACKGROUND

Originally, the normal window replacement technique due to broken

glass, scratches or any other defects of the windows in these vehicles, is that by being stuck directly onto the chassis, the frame supplied requires cleaning on the body itself of the vehicle in order to replace it and the subsequent placement of the new glass. This operation is carried out with the help of glue that is applied on the perimeter of the frame with the glass fittings. The problem with this glue is that it needs several days to dry and therefore the vehicle is left for a period of time without being able to be used.

The invention, object of this patent, is inspired by the European patent no. 05380259 by the same inventor, in which a flexible member is also included to release moving closures, and by the European patent no. EP 103822247 which includes that the flexible member for releasing moving closures is actuated by means of a key. These two inventions, which are revolutionary in this field, resolved the problem of being able to take out or remove the window quickly, each one with its mechanism, but did not enable it to be removed from the outside by the emergency services in the event of an accident or for maintenance reasons by workers.

The invention, object of this patent, improves what already exists to date given that by means of a double opening device, both outside and inside, it enables the actuation of the window frame release mechanisms of the corresponding rim thereof fixed on the chassis of the vehicle, and therefore enabling the quick and easy removal of the window in any of the events described above.

### DESCRIPTION OF THE INVENTION

The main purpose of the present invention described herein is to improve the problem of removing, changing or replacing the windows of the aforementioned vehicles and more specifically the waiting times, avoiding the need to break the glass using violent means, in the event of an accident, which may make the situation even worse, or in the case of maintenance, avoiding having the vehicle out of service for a long period of time, since the replacement of the damaged window, directly by another that is in stock, is immediate.

This problem is resolved by incorporating a double opening and closing device, therefore enabling actuation from both the outside of the vehicle and the inside.

The double opening device is situated on the fixed rim of the body of the

vehicle. This double opening device is made up of a box with two openings, one outside and the other inside, for locking keys to be inserted that enable a toothed part or wheel to be actuated. Therefore, the box may be of multiple shapes and sizes, as well as the openings and the locking keys. These shapes and sizes are determined by the Regulations of the different countries where this window may be introduced.

The toothed wheel is in contact with a toothed part. This toothed part is situated in the frame of the removable window. This toothed part is connected to a cord or cable, and which ends in a safety spring, all of this along the perimeter of the removable window frame. The toothed part and the cord are joined by means of a hook. In turn, sliding latches are joined to the cord, along the path thereof, each one formed of a blocking part with its corresponding rivets. So that the cord does not leave its path, there are guides along the path thereof.

When the toothed wheel situated in the fixed rim is mechanically actuated, it transmits the movement to the toothed part situated in the removable frame, and in this way it makes the cord move with all the elements associated with it. As it has been mentioned, there is a safety spring situated at the end of the path of the cord.

In turn, spaced grooves are provided on the contour of the fixed rim. When the window is closed, the sliding latches that are located in the removable frame do not coincide with the spaced grooves of the fixed rim, thus reaching a stop and the window cannot be removed. When the toothed wheel is actuated, the position of the toothed part changes, the sliding latches are situated over the grooves enabling the removable window to be released by unblocking or releasing the fastening, therefore carrying out the change or removal as quickly as possible.

The fixing of the fixed rim to the vehicle, as well as the profiles of the removable frame of the window, varies depending on the chassis of the vehicle in question.

In practice, aesthetic aspects must be taken into account. Therefore, the double opening device may have a different shape when seen from the outside of the vehicle compared with the inside.

It is considered more better-suited for the outside of the vehicle for the device to be able to be actuated by authorized personnel, such as emergency services, in order to remove the window quickly in the event of an accident, or by workers in the case of maintenance and therefore replacement. At this point an opening in the box would be enabled so as to be able to insert a safety key with a square head, for example.

From the point of view of the inside of the vehicle, the number of possibilities increases, given that, as well as in the case of the outside of the vehicle, it may be left so that it is only authorized by means of a safety key, but the most suitably and aesthetically noticeable solution is considered to be the one in which the safety key is coupled to the box of the device, and being handle shaped with bright colors wherever possible so that in the event of an emergency it may be easily actuated and located by the users of the vehicle. In this case, it is recommended that the location should be in a place out of the reach of children or where it may not be actuated by mistake. For this purpose, it may also be covered by a protective casing so that it is not actuated by mistake. As mentioned, there are countless aesthetic combinations.

To complete the present description, and for the purpose of aiding in a better understanding of the characteristics of the invention, a set of drawings is attached as an integral part thereof, wherein, by way of non-limiting examples, the following has been represented:

### DRAWINGS

FIG. 1.—A view of the window assembly from outside the vehicle.

FIG. 2.—A representation of the assembly in which the fixed rim, the removable frame and the double opening device may be seen.

FIG. 2.A.—A detailed enlargement of the double opening device.

FIG. 2.B.—A perspective view of the double opening device, showing the portion that is left exposed from the outside of the vehicle.

FIG. 2.C.—A perspective view of the double opening device showing the part that is left exposed from the inside of the vehicle.

FIG. 3.—A view of the window assembly from inside the vehicle, in which the double opening device with a handle may be seen.

FIG. 3.A.—A perspective view of a handle.

FIG. 4.—A plan view in which all the elements of the window assembly are visible.

FIG. 5.—A perspective view of the different elements that comprise the double opening device.

FIG. 6.—A cross-section of the double opening device assembly with the different parts that are included therein.

FIG. 7.—A cross-section of the assembly with the different parts that are included in the changeable window assembly in a closed position.

### DESCRIPTION OF THE DRAWINGS

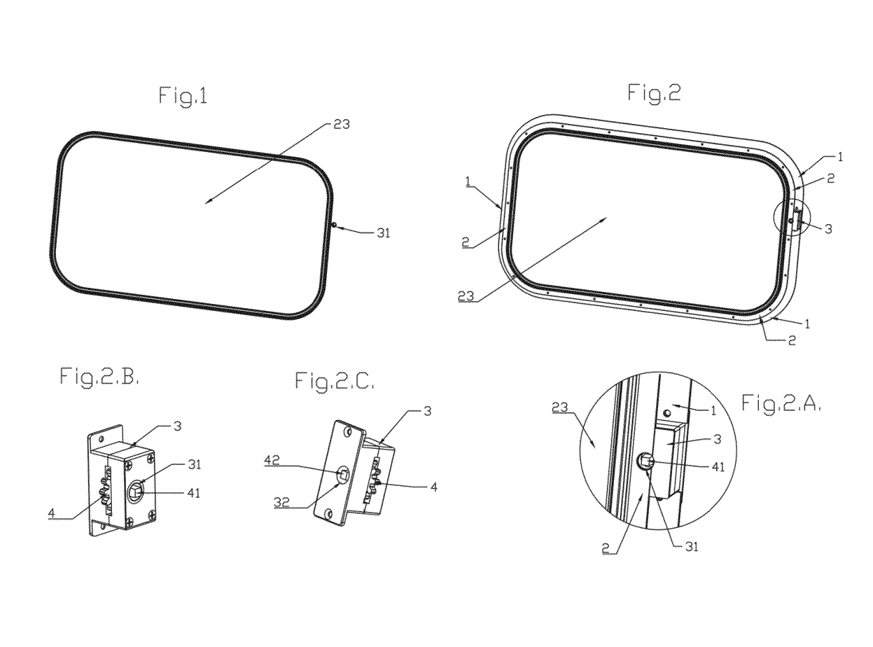

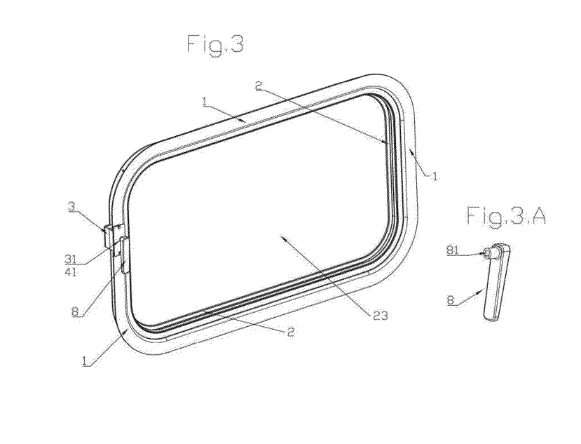

The double opening and closing device (FIG. 2A, FIG. 2B and FIG. 2C), which enables actuation from both outside the vehicle (FIG. 1) and inside (FIG. 2 and FIG. 3), is situated on the fixed rim (1) of the body (12) of the vehicle.

This double opening device is made up of a box (3) with two openings, one outside (31) and another inside (32), which enable the insertion of locking keys or other such items that enable a part or toothed wheel (4) to be actuated. Actuation from outside the vehicle is always via a key that couples perfectly to the pivot (41) of the outside opening (31). Actuation from inside may have different options; the inside opening (32) may given a pivot (42) to be actuated with a specific key or, for example, it may have a handle (8) (FIG. 3A) with the complementary pivot element (81) that enables handle-pivot coupling.

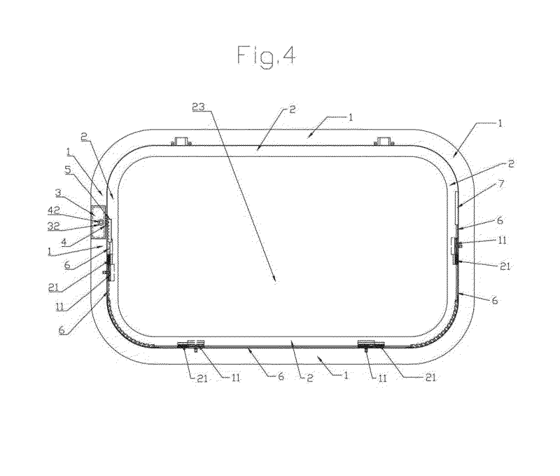

The toothed wheel (4) is in contact with a toothed part (5). This toothed part (5) is situated in the frame of the removable window (2). This toothed part (5) is connected to a cord (6) or cable, and the cord (6) ends in a safety spring (7), all of this along the perimeter of the removable window frame (2) (FIG. 4 and 5).

The toothed part (5) and the cord (6) are joined by means of a hook. In turn, sliding latches (21) are joined to the cord (6), along the path thereof, each one formed of a blocking part with the corresponding rivets thereof, which enable a perfect fit with the spaced groove (11) that will be described below. So that the cord does not leave its path, there are guides along the path thereof.

When the toothed wheel (4) situated in the fixed rim (1) is actuated, it transmits the movement to the toothed part (5) situated in the removable frame (2), and in this way it makes the cord (6) move with all the elements associated with it. As mentioned, a safety spring (7) is situated at the end of the path of the cord.

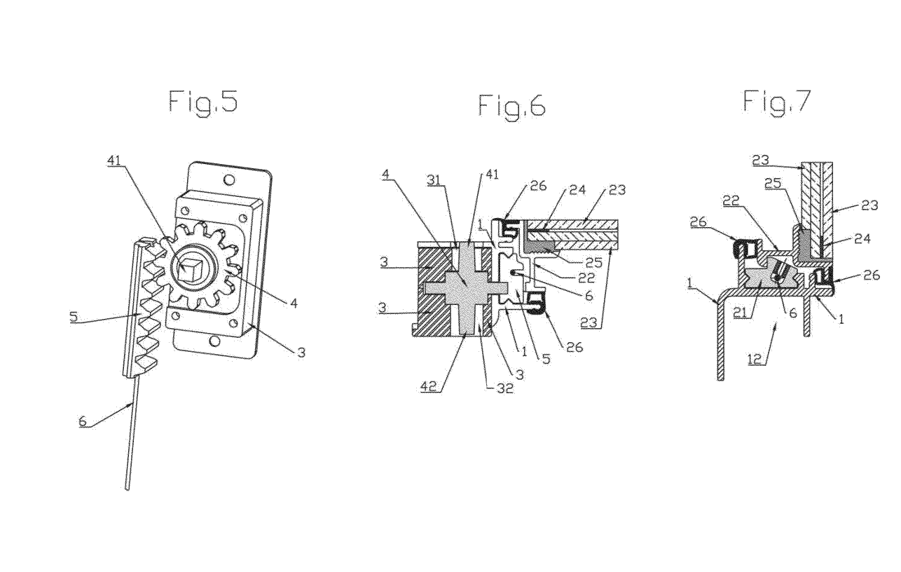

When the window is closed, the sliding latches (21) that are located in the removable frame (2) do not coincide with the spaced grooves (11) of the fixed rim (1), thus reaching a stop and the window may not be removed. When the toothed wheel (4) is actuated, the position of the toothed part (5) changes, the sliding latches (21) are situated over the spaced grooves (11) enabling the removable window to be released by unblocking or releasing the fastening, therefore carrying out the change or removal as quickly as possible (FIG. 6).

The fixing of the fixed rim (1) to the vehicle changes depending on the chassis (12) of the vehicle in question, as well as the profiles (22) of the removable frame (2) of the window. In general, the removable frame (2) is made up of profiles (22) on which the glass (23) and the spacers (24) are supported, which are stuck with glue (25). Joints (26) that ensure the watertight sealing of the assembly are placed between the fixed rim (1) and the removable frame (2) (FIG. 7).

Having sufficiently described the nature of the invention above, taking into account that the terminology that has been used in this specification should be taken in a broad and non-limiting sense, as well as the description of the best mode of carrying it out in practice, the registration of the patent is requested, as it has been proven that it constitutes a positive technical advancement, the essence of said invention being what is specified below in the following claims.

1. A removable, changeable and replaceable window, for application on train carriages, passenger buses and other transport vehicles, that, consists of an assembly formed of a removable window frame (2) and its corresponding rim (1) fixed on the chassis (12) of the vehicle, wherein the assembly is characterized in that it is provided with a double opening device made up of a box (3) that enables keys to foe inserted both from outside the vehicle and inside the vehicle that enable a toothed part or wheel (4) to foe actuated, which is in contact with a toothed, part (5), this toothed part (5) being connected to a cord (6) that runs, by means of certain guides, along the entire perimeter of the window frame (2) up to a safety spring (7) and in which there are sliding latches (21), there being spaced grooves (11) in the fixed rim (1); and that once the toothed wheel (4) is actuated it transmits the movement to the toothed part (5), making the cord (6) and the sliding latches (21) move along the removable frame (2) and coincide with the spaced grooves (11) of the fixed rim (1) and therefore being able to remove the frame (2).

2. The removable, changeable and replaceable window, according to the characteristics of claim 1, wherein the double opening device is characterized in that it is made up of a box (3) with two openings, one outside (31) and another inside (32), where an equal number of pivots (41 and 42) are found, to which the specific keys couple in order to actuate the toothed wheel (4) that is in contact with the toothed part (5).

3. The removable, changeable and replaceable window, according to the characteristics of claim 1, which is characterized in that the inside actuating key is a handle (8).

4. The removable, changeable and replaceable window, according to the characteristics of claim 1, wherein the fixed rim (1) and the removable frame (2) are characterized in that they have a certain configuration and profiles depending on the chassis (12) of the vehicle, there being joins (26) that ensure the watertight seal between said fixed rim (1) and removable frame (2).

5. The removable, changeable and replaceable window, according to the characteristics of claim 1, wherein the removable frame (2) is characterized in that it is formed of profiles (22) on which the glass (23) and the spacers (24) rest, being joined together by means of gluing (25).
